(19) United States
(12) Patent Application Publication
(10) Pub. No.: US 2012/0193890 A1
(43) Pub. Date: Aug. 2, 2012

(54) Fifth Wheel Trailer Hitch Cover

(76) Inventor: Kim David Rogers, Stanwood, WA (US)

(21) Appl. No.: 13/249,693

(22) Filed: Sep. 30, 2011

Related U.S. Application Data
(60) Provisional application No. 61/462,060, filed on Jan. 28, 2011.

(51) Int. Cl. B60D 1/60

(52) U.S. Cl. 280/507

(57) ABSTRACT

A cover for a fifth wheel trailer hitch that includes a rigid body with a front planar section and a rear planar section. Formed on the front planar section is a downward extending lip that engages the front edge of the head assembly on the hitch. The cover includes a holding mechanism for preventing the cover from moving forward and laterally over the head assembly. In two embodiments, the holding mechanism is a pivoting torsion plate attached to the bottom surface of the cover that presses against the rear portion of the head assembly. In another embodiment, the torsion plate is replaced by a center post with lateral beveled ears that slide into the head assembly's pin slot. In a fourth embodiment, the holding mechanism is at least one downward biasing clip attached to the cover's rear section that presses against the rear portion of the head assembly.

This utility patent application is based on and claims the filing date benefit of U.S. provisional patent application (Application No. 61/462,060) filed on Jan. 12, 2011.

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention pertains to covers, and more particular to covers used with fifth wheel trailer hitches.

2. Description of the Related Art

Light to medium recreational trailers and equipment are commonly hauled on a hitch securely mounted on the bed of truck. The hitch, called a fifth wheel hitch, is similar to a hitch used on a semi-truck, and designed to carry much heavier loads than a typical ball hitch. It is usually mounted on the truck bed and directly over the rear axle.

The fifth wheel hitch includes a large horseshoe plate, called a head assembly that attaches to rails directly connected to the bed or to the sides of the truck. The head assembly includes a front section and a rear section. The front section has a relatively straight front edge. The rear section includes a longitudinally aligned slot designed to receive a vertically aligned king pin extending downward from a rest plate located on the front portion of the trailer. When attaching the truck to the trailer, the truck is backed up and aligned with the trailer so that the rest plate and king pin slides over the head assembly and the slot, respectively. Once properly positioned, the trailer is then lowered onto the bed so that king pin may be locked in place by a hitch hook assembly. Because the head assembly and rest plate must slide together, grease may be applied to the head assembly which is exposed when the trailer is disconnected from the hitch.

Many truck owners detach their trailers from the truck so that the truck may be driven without the trailer. Because the fifth wheel hitch is exposed to rain and dirt, the head assembly may rust and the slot and king pin hole may become clogged with debris. Also, because the head assembly takes up a large amount of bed space, cargo placed into the bed may contact the grease on the head assembly and become soiled.

What is needed is fifth wheel hitch cover that protects the head assembly that can be easily detached and removed from a fifth wheel hitch without tools, remains securely attached over the head assembly when properly attached, and is not damaged when in contact with grease applied to the head assembly.

### SUMMARY OF THE INVENTION

It is an object of the present invention to provide a cover for a fifth wheel hitch to protect the head assembly used on the hitch from rain and debris.

It is another object of the invention to provide such a cover that also shields the hitch covered with lubrication from impacting cargo placed in the bed.

It is another object of the present invention to provide such a cover that easily and securely attaches to different head assemblies.

These and other objects are satisfied by the four embodiments of hitch cover described and shown herein. Each embodiment of the cover includes a rigid body with a large, planar front section and a small, planar rear section. The front section is designed to completely cover the front portion of the head assembly while the rear section is designed to completely cover the rear portion of the head assembly including the two beveled rear leaves, the slot, and the king pin hole. Formed on the front edge of the cover's front section is a perpendicularly aligned edge that extends over the front edge of the head assembly. During use, the front edge of the cover snap fits over the front edge of the head assembly and prevents the cover from being lifted upward and from moving rearward over the head assembly.

In all embodiments, the cover includes a holding mechanism that prevents the rigid body from moving forward and laterally when disposed over the head assembly. In the first and second embodiments, the holding mechanism is a torsion plate attached to the bottom surface of the rear section of the cover. The torsion plate includes a conical-shaped center tab and two outer tabs. The torsion plate is pivotally attached to biasing means that automatically forces the torsion plate against the inside surface of the head assembly when attached to the head assembly. A pull ring or gripping surface on the first and second embodiments, respectively, is pulled when attaching and detaching the cover to the head assembly. In the second embodiment, the torsion plate may be adjustably connected to the bottom surface of the cover so that the cover may be used with different head assemblies.

In a third embodiment, the mechanism for temporarily holding the cover to the head assembly is a center post that extends downward from the bottom surface of the cover and slides into the head assembly's pin slot. Formed on the post are two lateral ears that extend laterally and engage the bottom surfaces of the adjacent surfaces of the front and rear portions of the head assembly as the post slides forward in the pin slot. The lateral ears are beveled upward from a fore to aft orientation which enables the cover to easily slide forward over the head assembly and simultaneously over the pin slot and king pin hole and securely attaches the cover to the head assembly.

In a fourth embodiment, the cover includes at least one biasing clip located on the bottom surface of the rear planar section. The cover is longitudinally aligned behind the fifth wheel hitch and then slid forward so that biasing clip engages the inside surface of the head assembly to securely hold the cover in place.

In all embodiments, an optional cable or chain that extends from the cover to the bed or to the head assembly is provided to prevent the cover from be blown off the bed when not in used.

### DESCRIPTION OF THE DRAWINGS

FIG. 1 is a top plan view of a fifth wheel trailer hitch with the first embodiment of the cover attached thereto.

FIG. 2 is a side elevational view of the cover and hitch shown in FIG. 1.

FIG. 3 is a bottom plan view of the cover shown in FIGS. 1 and 2.

FIG. 4 is a side elevational view showing the cover being removed from the head assembly.

FIG. 5 is a bottom view of a head assembly with the second embodiment of the cover attached thereto.

FIG. 6 is a side elevational view of the second embodiment of the cover shown in FIG. 5.

FIG. 7 is a side elevational view of the second embodiment of the cover similar to the view shown in FIG. 6 showing the release arm be rotated to move the torsion plate in position for attached or detachment from the head assembly.

FIG. 8 is a bottom view of the second embodiment of the cover.

FIG. 9 is a side elevational view of a third embodiment of the cover that includes a post that fits into the pin slot.

FIG. 10 is a bottom plan view of the cover shown in FIG. 9.

FIG. 11 is a sectional view of the cover taken along line 11-11 in FIG. 10.

FIGS. 12-14 are sequential side elevational views showing a fourth embodiment of the cover being attached to the head assembly.

FIG. 15 is a top plan view of the fourth embodiment of the cover shown in FIGS. 12-14 attached to a head assembly.

FIG. 16 is a bottom plan view of the cover shown in FIGS. 12-15.

### DESCRIPTION OF THE PREFERRED EMBODIMENT(S)

Referring to the accompanying Figs., there is shown four embodiments, indicated by the reference numbers 10, 10′, 10″ and 10″′ designed to be easily attached to the fifth wheel hitch 90 attached to the bed 200 of a truck to protect the head assembly 91 from rain and debris and to protect cargo (not shown) that may be placed into the bed 200 and impact the hitch 90. The hitch 90 includes a pivoting, plate-shaped head assembly 91 that includes a planar front portion 92, a planar rear portion 94, a pin slot 102 and a pin hole 104. The front edge 93 on the front portion 92 is relatively straight.

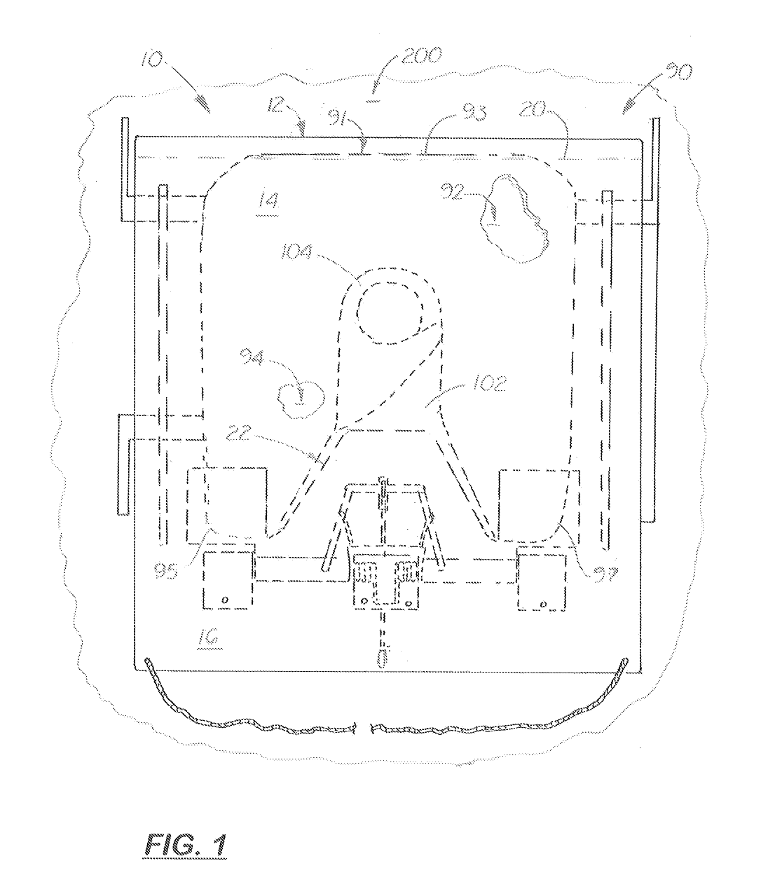

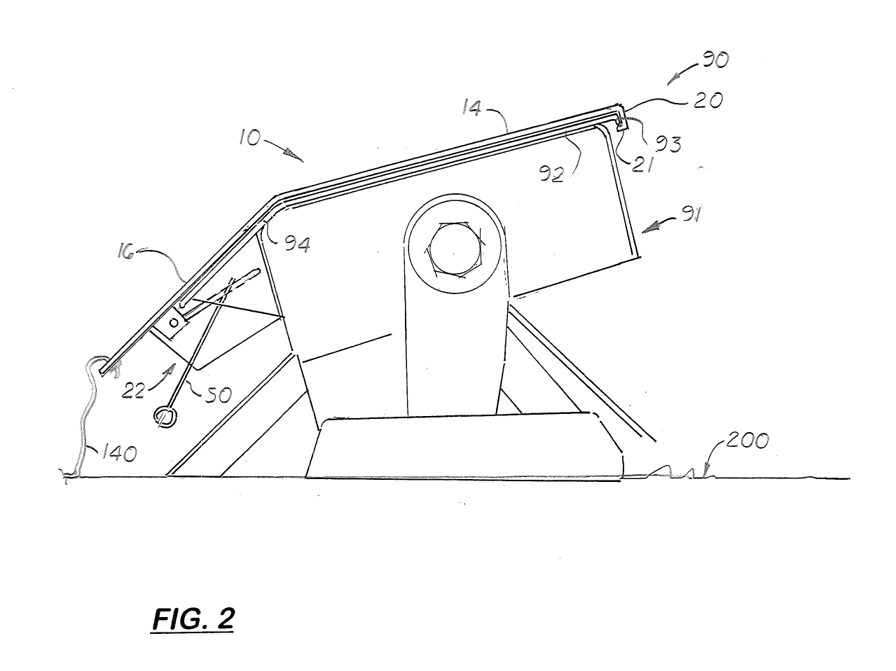

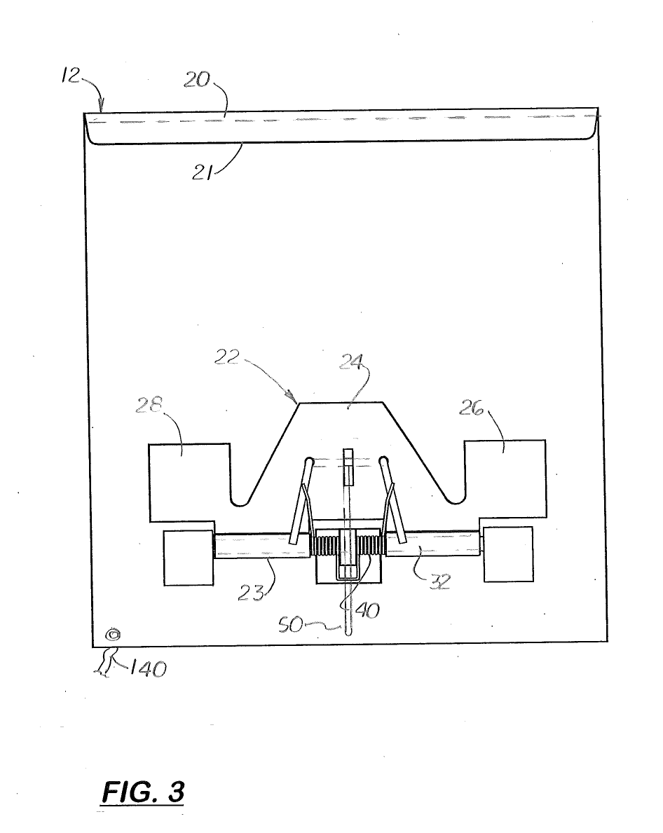

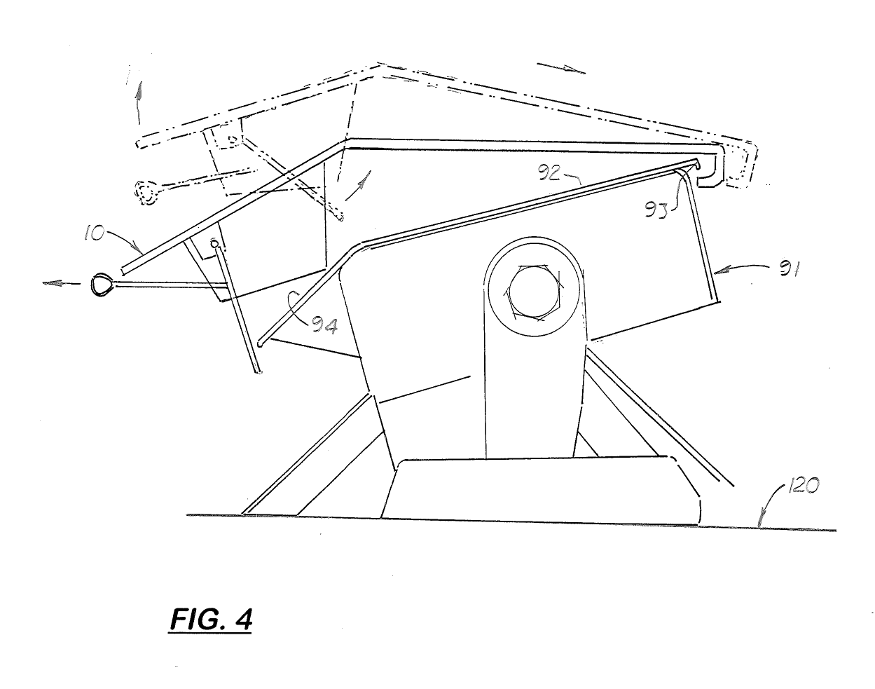

In a first embodiment, shown in FIGS. 1-4, the cover 10 includes a rigid top plate 12 with a large planar front section 14 and a smaller, planar rear section 16. The large front section 14 is designed to cover the front portion 92 of the head assembly 91 while the rear section 16 is designed to cover the slot 102 and pin hole 104 and the two diagonally aligned, beveled rear leaves 95, 97 that extend rearward and downward from the front section 14. During operation, the two rear leaves 95, 97 extend under the trailer and help guide the pin (not shown) into the fifth wheel hitch 90.

Formed on the front edge of the cover's front planar section 14 is a perpendicularly abutment wall 20. On the cover 10, a rearward extending lip 21 is formed on the lower portion of the wall 20. During installation of the cover 10, the abutment wall 20 extends over the front edge 93 of the front portion 92 of the head assembly 91 and the lip 21 extends partially under the front edge 93 to keep the cover 10 from lifting upward and from moving rearward.

Attached to the bottom surface of the rear section 16 of the cover 10 is a torsion plate 22. The torsion plate 22 includes a wide, conical-shaped center tab 24 and two outer square tabs 26, 28. The rear edge of the torsion plate 22 is pivotally attached to a rod 32 so that the torsion plate 22 is automatically forced inward and against the inside surface of the rear section 16 of the cover 10 when not in use. During use, the center tab 24 is pulled downward so that it fits across the pin slot 102 and the two outer square tabs 26, 28 are positioned under the head assembly's two rear leafs 95, 97, respectively, The cover 10 is forced downward over the rear section 93 by the biasing force created by the two tables 26, 28 to hold the cover 10 in place on the head assembly 91. The biasing force is created by a torsion spring 40 disposed between the torsion plate 22 and the rear portion 16 to cover 10. Attached to the torsion spring 40 is a release arm 50 that allows the tension of the torsion spring 40 to be manually overcome so that the cover 10 may be removed from the head assembly 91.

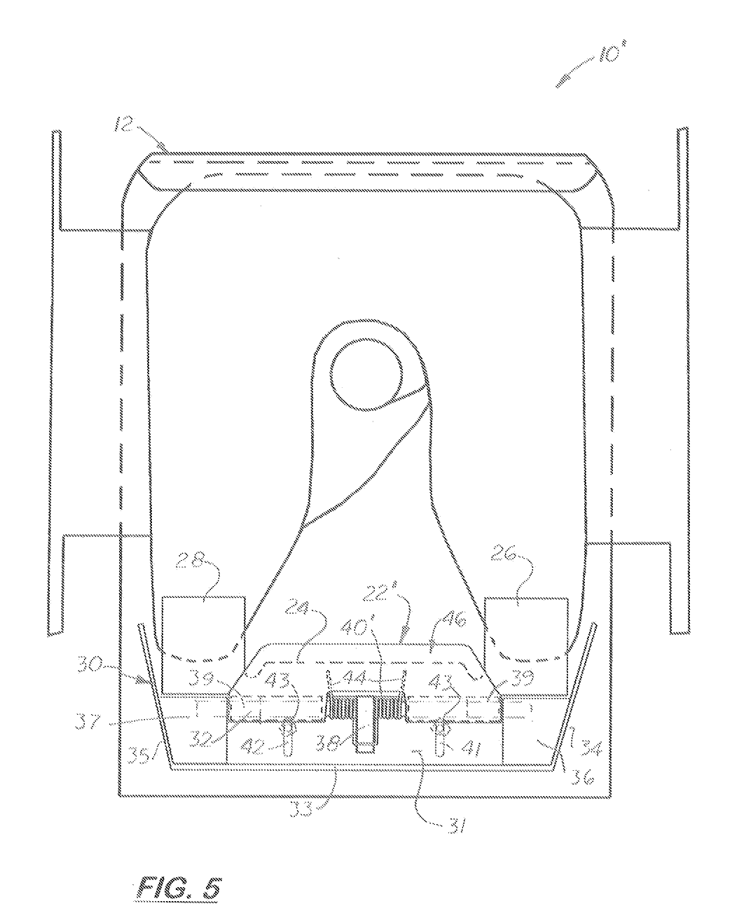

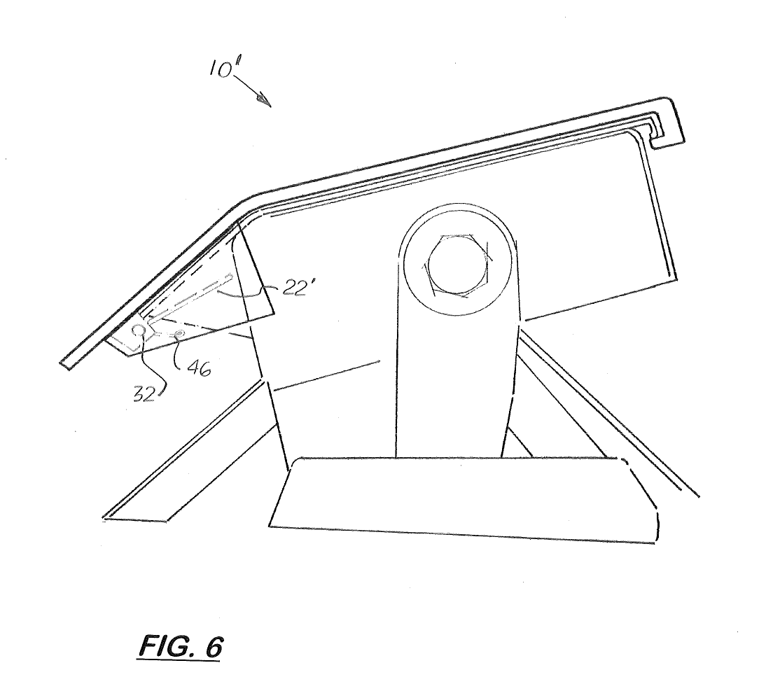

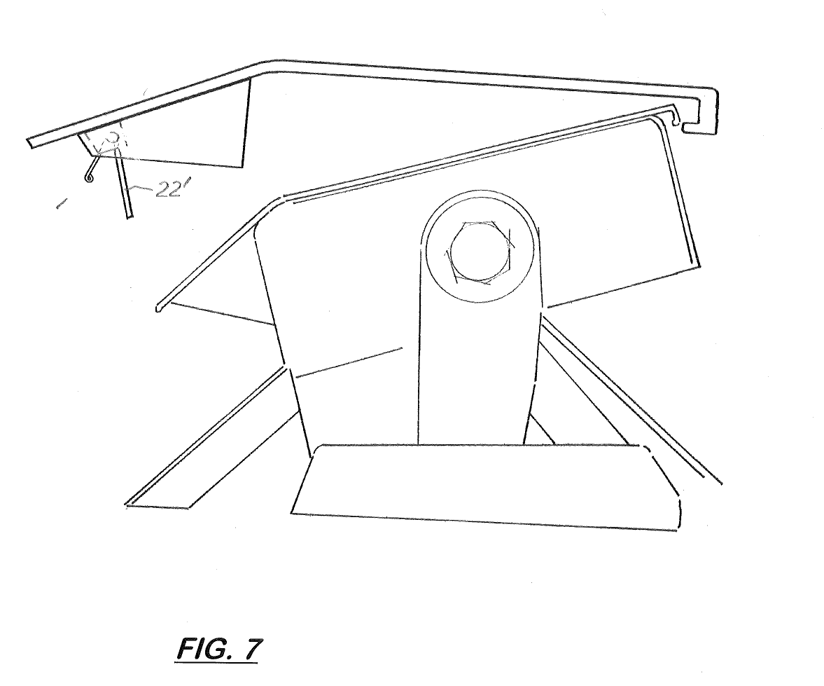

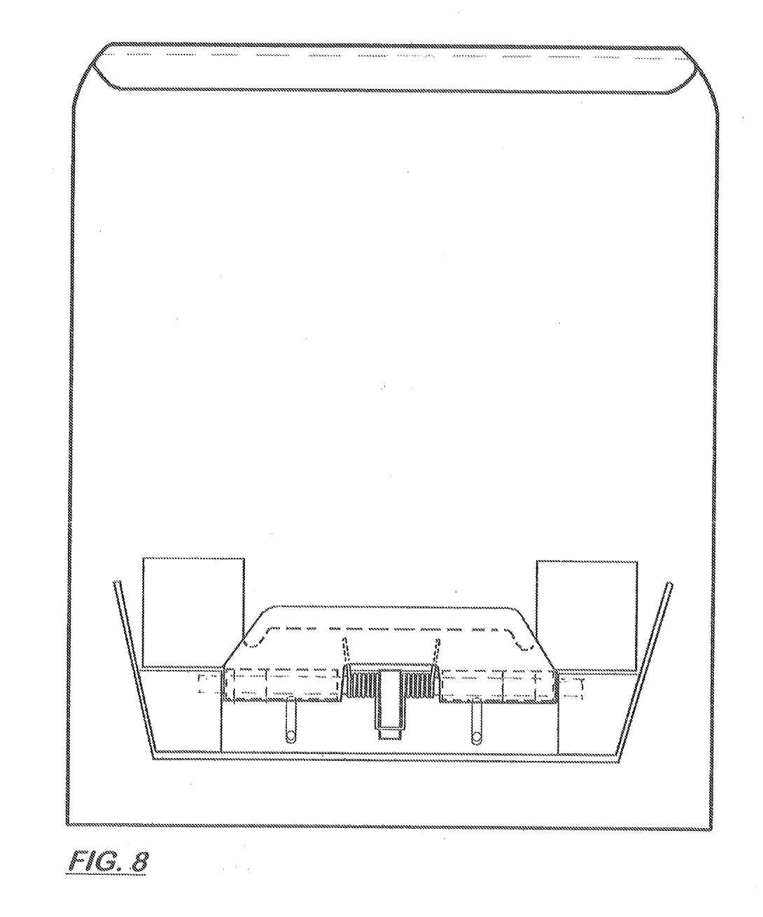

FIGS. 5-8 show a second embodiment of the cover, denoted 10′, in which a modified tension plate 22′ is used that includes a conical shaped center tab 24′ and two outer square tabs 26′, 28′ attached to an adjustable secondary platform 30 that is selectively attached to the bottom surface of the rear section 16′ of the cover 10′. The secondary platform 30 includes a transversely aligned top plate 31, a transversely aligned rear plate 33, and two vertically aligned, diagonal side plates 34, 35. Mounted on the inside surfaces of the two side plates 34, 35 and to the bottom surface of the top plate are two support blocks 36, 37. Located centrally and extending downward from the top plate 31 is a center support block 38. Formed on the top plate 31 are two elongated slots 41, 42 through which adjustment bolts 43 extend. During assembly, the secondary platform 30 may be moved forward or rearward along the rear section 16′ to allow the cover 10′ to accommodate different sizes and shapes of head assemblies 91.

Extending between the end support blocks 36, 37 and through the center block 38 is a tension rod 32. The tension rod 32 extends through two cylindrical collars 39 attached to the bottom surface of the torsion plate 22′ thereby coupling the torsion plate 32 to the tension rod 32. Disposed around the tension rod 32 and around the center block 38 is a dual leg tension spring 40′. The tension spring 40′ includes two legs 44, 44′ that press against the bottom surface of the center tab to force the torsion plate 22′ upward and against the bottom surface of the head assembly. In the second embodiment, the pull ring 50 used in the first embodiment of the cover 10, is replaced by a downward extending release arm 46 integrally formed on the torsion plate 22′ the user can easily grip to overcome the tension force to attached and removed the cover 10′ from the head assembly.

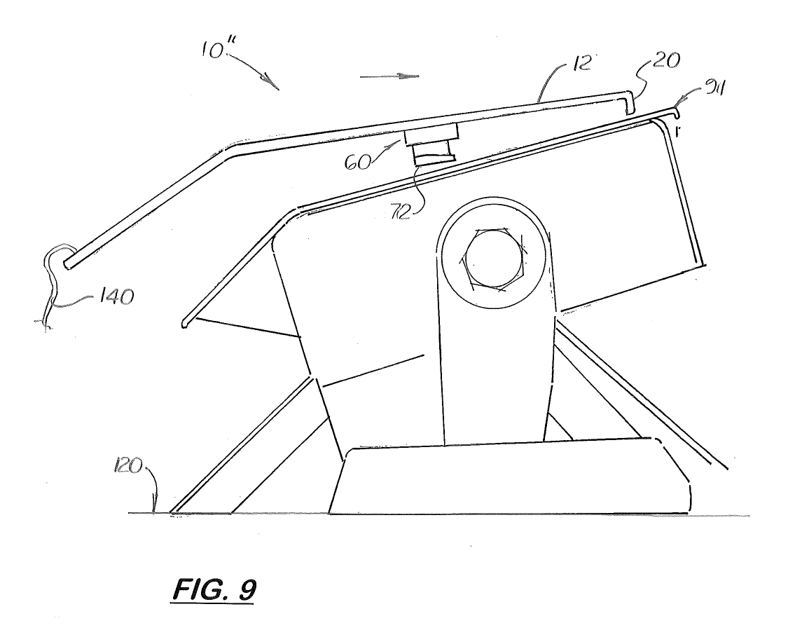

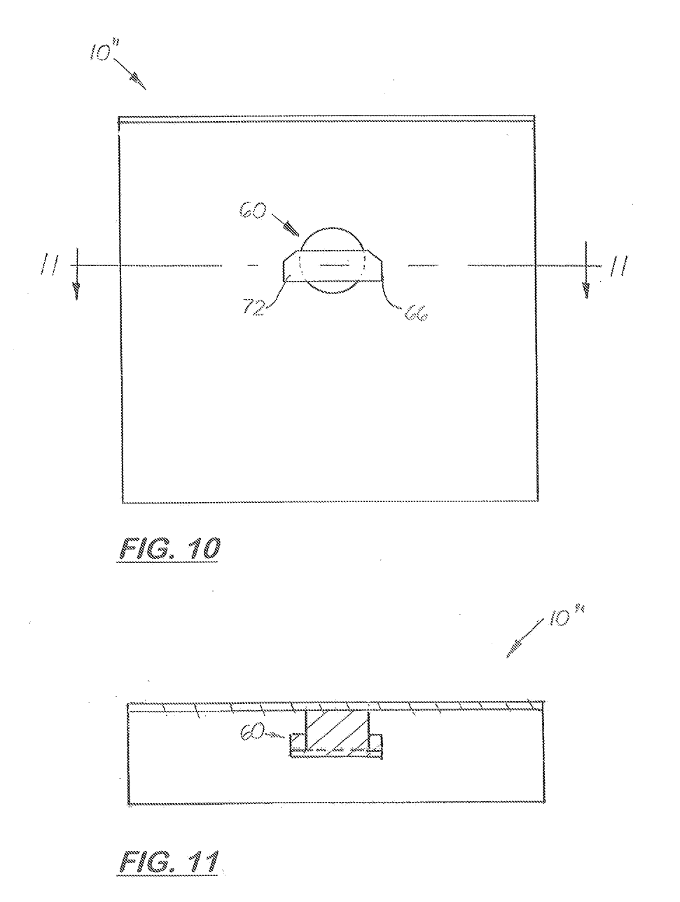

In a third embodiment shown in FIGS. 9-11, the cover 10″ includes a similar main body 12 with a center post 60 that extends downward from the front portion 14 and during installation, slides through the pin slot 102 and into the hole 104 (shown in FIG. 1) Formed on the post 60 are two lateral beveled ears 66, 72. When the cover 10′ is properly positioned over the head assembly 91, the center post 60 extends into the pin slot 102 and the two ears 66, 72 extend under the adjacent bottom surfaces of the head assembly's front or rear portions 92, 94. Because the two lateral ears 66, 72 on the post 60 are beveled upward from a fore to aft direction (see FIG. 5), the user is able to slide the cover 10′ forward so that the post 60 slides into the pin slot 102 and the two ears 66, 72 press against the bottom surface of the head assembly 91 to securely hold the cover 10′ in place. On cover 10′, the lip 21 on the front edge 20 of the body 12 is optional.

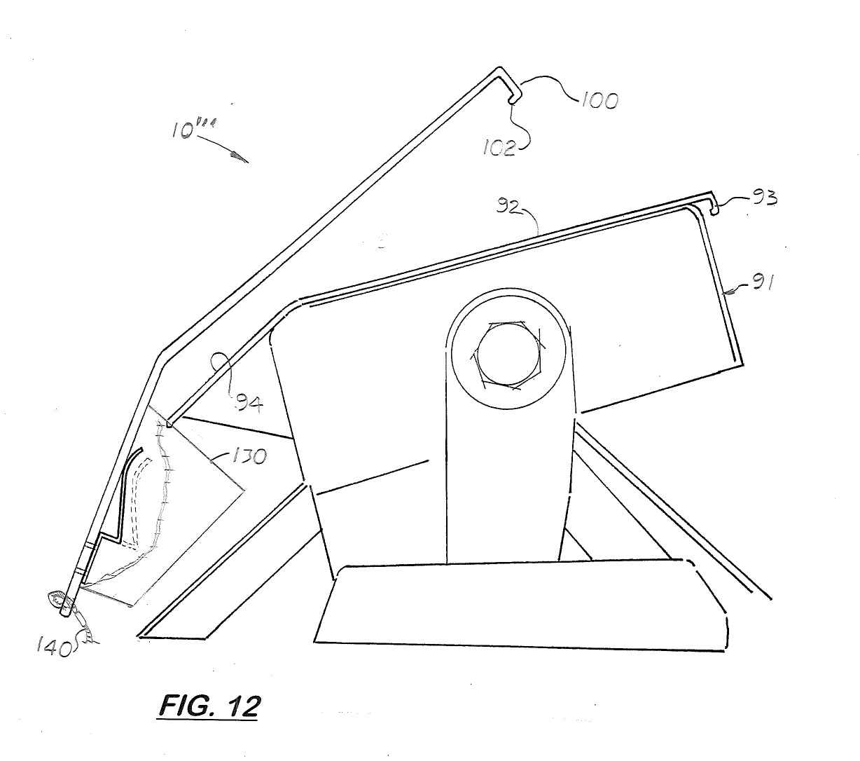

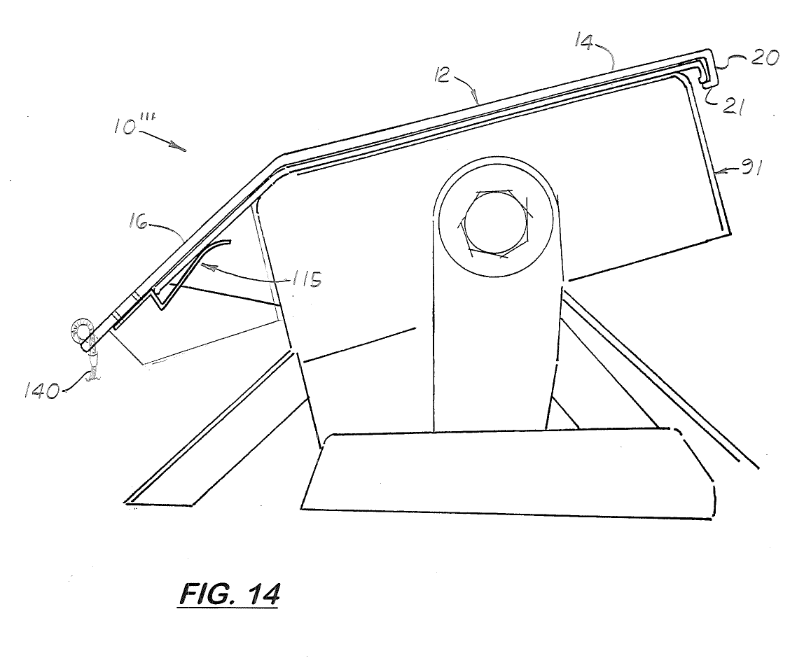

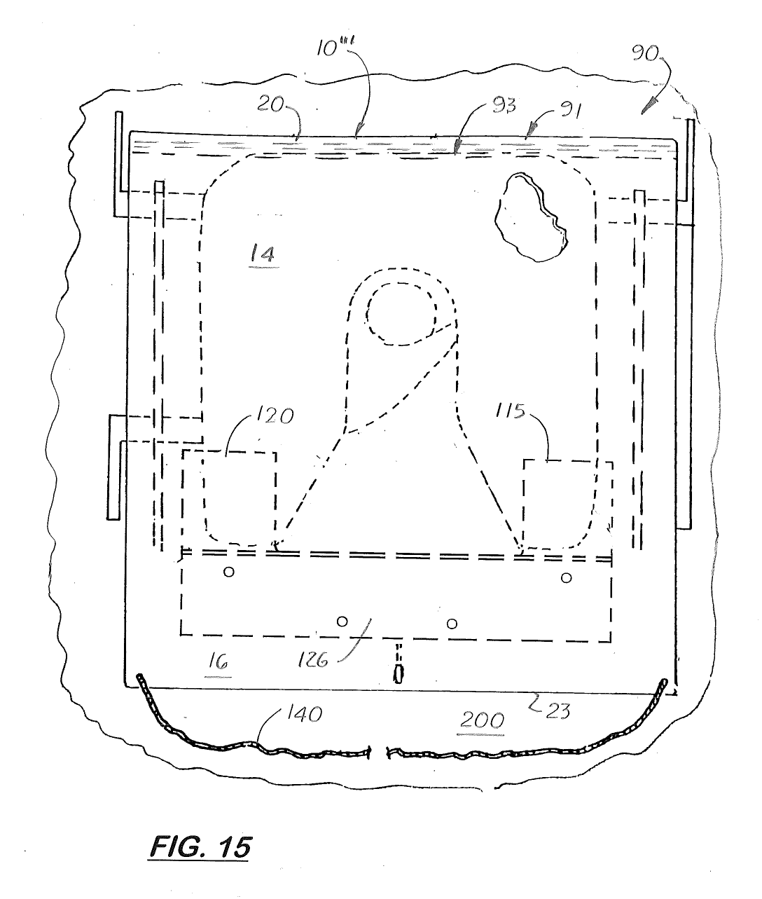

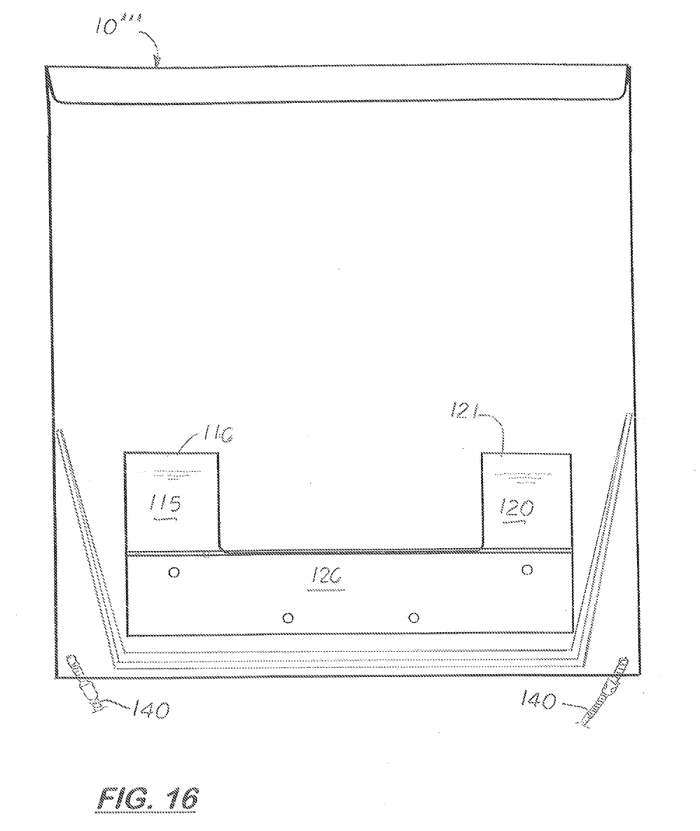

A fourth embodiment of the cover 10″′, shown in FIGS. 12-16, is designed to be longitudinally aligned behind the hitch 90 and then slid forward so that two longitudinally aligned biasing clips 115, 120 located on the bottom surface of the cover 10″′ are forced outward to engage the inside surface of the head assembly 91. The two clips 115, 120 are biased inward so that they securely hold the cover 10″′ in place on the head assembly 91.

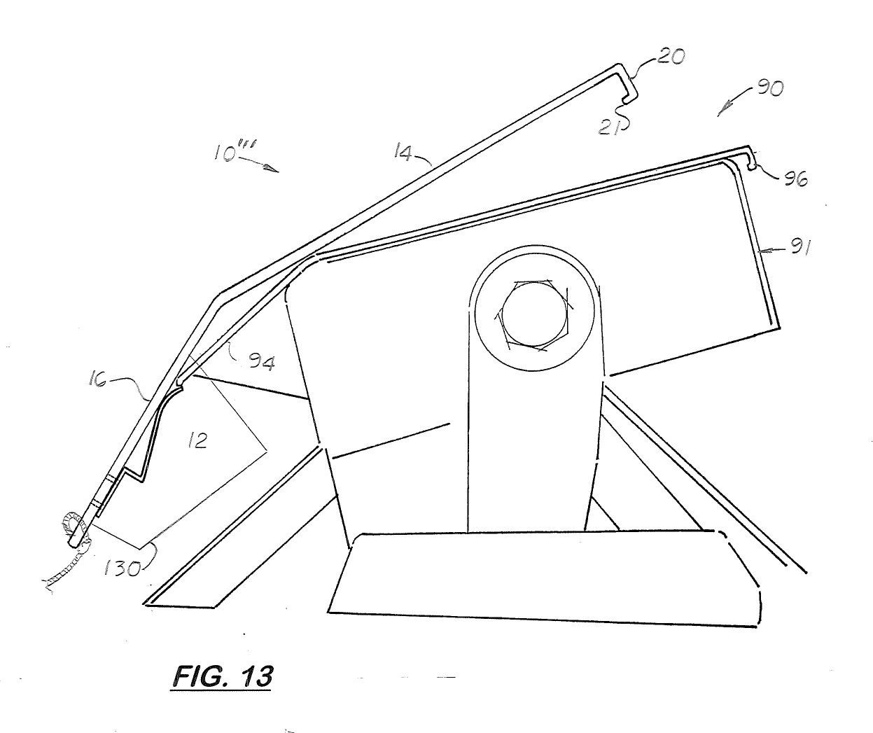

Cover 10″ includes a main body 12 that has the same general shape as the main bodies 12 used in the first and second embodiments of the cover 10, 10′. The body 12 includes a top plate 12 with a front planar section 14 and a rear planar section 16. Formed along the front edge of the front planar section 14 is a short vertical abutment wall 20 with a rearward extending lip 21 formed thereon. The length and shape of the abutment wall 20 and the rearward lip 21 are sufficient so that they extend around the hitch's front edge 93 and are engaged thereon. As stated above, the two biasing clips 115, 120 are designed to provide sufficient biasing forces on opposite sides of the cover 10″ to hold the rear planar section 16 of the cover 10″ in place of the rear portion of the hitch 90. As shown in FIGS. 12 and 13 the two biasing clips 115, 120 are part of a rectangular plate 126 that is transversely aligned and attached to the bottom surface of the rear planar section 16. The outer sections of the plate 126 are first bent outward at a first angle at or near 90 degrees and then bent inward at a second angle approximately 70 degrees. The front edges 116, 121′ of the two clips 115, 120, respectively, are curved outward so the rear edge of the head assembly 91 may be engaged as the cover 10″slides forward over the head assembly 91 hitch. The clips 115, 120 may be manufactured in different sizes to accommodate different plate thicknesses used with different head assemblies.

In the fourth embodiment of cover 10″, attached to the bottom surface of the rear planar section 16 is an optional three sided skirt 130 designed to prevent water and debris from contacting the head assembly 91.

In each embodiment, an optional cable or chain 140 is provided that extends from the cover 10, 10′, 10″, 10″′ to the bed of the truck or to the fifth wheel hitch 90 that prevents the cover 10, 10′, 10″, 10″′ from be blown out of bed when driving.

The four embodiments of the covers 10, 10′, 10″ and 10″′ are made of durable material compatible with water, snow, direct sunlight, oil and grease, and light to moderate impacts with cargo items. In the preferred embodiment, the covers 10, 10′, 10″ are made of ⅛ to ¼ inch thick plastic or 1/16-⅛ inch thick aluminum or steel metal.

All of the covers 10, 10′, 10″ and 10″′ area attached to the head assembly 91 in a similar manner. For example when using the second embodiment of the cover 10′, the cover 10′ is first aligned and registered over the head assembly 91. The cover 10′ is then moved rearward with the cover's front section and front edge slightly elevated over the front section. The rear section is then lowered and moved rearward so that the cover's rear edge is behind and below the rear edge of the head assembly. While holding the rear section 16 downward, the cover 10 is then simultaneously pushed forward and the front section 14 is rotated downward so that the front section 14 is forced forward and downward so that the cover's front lip 21 engages the front lip 93 on the head assembly 91. As the cover 10″ is moved forward, the two clips 115, 120 slide under and engage the rear section 93 of the head assembly 91. To remove the cover 10′ from the hitch, the process is reversed.

In compliance with the statute, the invention described herein has been described in language more or less specific as to structural features. It should be understood however, that the invention is not limited to the specific features shown, since the means and construction shown, is comprised only of the preferred embodiments for putting the invention into effect.

The invention is therefore claimed in any of its forms or modifications within the legitimate and valid scope of the amended claims, appropriately interpreted in accordance with the doctrine of equivalents.

I claim:

1. A cover for a fifth wheel hitch that includes a head assembly that includes a front section, a rear section and a pin slot, the cover comprising:
a. a rigid body that covers the head assembly on a fifth wheel hitch, said rigid body includes a front planar section that extends over the front section of said head assembly and a rear planar section that extends over the rear section and said pin slot on said head assembly;
b. a downward extending edge formed on said front planar section the extends downward over a front edge on said front section of said head assembly; and,
c. a holding mechanism for selectively attaching said rear planar section of said body over said rear section of said head assembly.

2. The cover as recited in claim 1, further including a connecting cable or chain connected to said cover and said truck or head assembly that prevents said cover when detached from said head assembly from being blown away.

3. The cover as recited in claim 1, wherein said holding mechanism is at least one biasing clip attached to a bottom surface of said rear planar section that sliding engages said rear section of said head assembly when said cover is positioned behind and forced forward over said head assembly.

4. The cover as recited in claim 3, wherein said body is made of plastic.

5. The cover as recited in claim 3, wherein said body is made of metal.

6. The cover as recited in claim 3, further including a connecting cable or chain connected to said cover and said truck or head assembly that prevents said cover when detached from said head assembly from being blown away.

7. The cover as recited in claim 4, further including a connecting cable or chain connected to said cover and said truck or head assembly that prevents said cover when detached from said head assembly from being blown away.

8. The cover as recited in claim 1, wherein said holding mechanism is two biasing clips are attached to a bottom surface of said rear planar section that sliding engages said rear section of said head assembly when said cover is positioned behind and forced forward over said head assembly.

9. The cover as recited in claim 8, further including a connecting cable or chain connected to said cover and said truck or head assembly that prevents said cover when detached from said head assembly from being blown away.

10. The cover as recited in claim 8, wherein said body is made of plastic.

11. The cover as recited in claim 10, further including a connecting cable or chain connected to said cover and said truck or head assembly that prevents said cover when detached from said head assembly from being blown away.

12. The cover as recited in claim 8, wherein said body is made of metal.

13. The cover as recited in claim 12, further including a connecting cable or chain connected to said cover and said truck or head assembly that prevents said cover when detached from said head assembly from being blown away.
